(19) United States
(12) Patent Application Publication
(10) Pub. No.: US 2008/0072263 A1
(43) Pub. Date: Mar. 20, 2008

(54) Method and apparatus for transmitting digital broadcasting in mobile communication terminal

(75) Inventor: Kang Wook Kim, Daegu Metropolian City (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/899,911

(22) Filed: Sep. 6, 2007

(30) Foreign Application Priority Data
Sep. 18, 2006 (KR) 2006-0089959

(51) Int. Cl. H04N 7/16; H04M 1/00

(52) U.S. Cl. 725/62; 455/556.1

(57) ABSTRACT

A method for transmitting digital broadcasting in a mobile communication terminal having a digital broadcasting receiver includes: performing a video call by converting an image signal output from a camera module into image data for transmission and transmitting the image data for transmission; and replacing, upon receipt of a request to replace an image while performing the video call, the image data for transmission with broadcast data for transmission obtained by converting a broadcast signal received from the digital broadcasting receiver and transmitting the broadcast data for transmission. The method enables transmission of broadcast data for transmission obtained by converting a broadcasting signal received during a video call while maintaining a video call connection, thus enabling viewing of real-time digital broadcasting on a mobile communication terminal not equipped with a Digital Multimedia Broadcasting (DMB) receiver by using a video call function.

### CLAIMS OF PRIORITY

This application claims priority to an application entitled “METHOD AND APPARATUS FOR TRANSMITTING DIGITAL BROADCASTING IN MOBILE COMMUNICATION TERMINAL” filed in the Korean Intellectual Property Office on Sep. 18, 2006 and assigned Serial No. 2006-0089959, the contents of which are incorporated herein by reference.

### BACKGROUND OF THE INVENTION

1. Field of the Invention

The present invention relates to a mobile communication terminal, and more particularly, to a method and apparatus for transmitting digital broadcasting in a mobile communication terminal that enable transmission of a digital broadcast image to another party using a video call.

2. Description of the Related Art

Earlier, a mobile communication terminal had voice call and short message service (SMS) functions. However, recently, rapid development of mobile communication technology has enabled a mobile communication terminal to support diverse and sophisticated functions including video calls, electronic-note function, audio/image storage, Internet access, entertainment features, and digital camera function. Further, a digital camera function of a mobile communication terminal enables a user to easily take desired motion video images and still images for storage and make a video call to another user through an embedded digital camera.

Recently, a mobile communication terminal having a digital broadcast view function in addition to the aforementioned functions has been developed. A digital broadcast view function enables use of Digital Multimedia Broadcasting (“DMB”) services through a mobile communication terminal. A DMB service refers to a broadcasting service capable of providing various digitally modulated multimedia (audio and video) signals to a portable or in-vehicle terminal. The DMB service is based on a digital radio standard of Digital Audio Broadcasting (DAB), to which multimedia broadcasting services are added, and thereby provides motion videos and data such as weather reports, news, and location information.

In order to view digital broadcasts through a mobile communication terminal, the mobile communication terminal requires a digital broadcasting receiver. Thus, a conventional mobile communication terminal without a digital broadcasting receiver cannot receive digital broadcasts.

### SUMMARY OF THE INVENTION

The present invention provides a method and apparatus for transmitting digital broadcasting in a mobile communication terminal using a video call that enable viewing of digital broadcasts without need of a digital broadcasting receiver.

According to an exemplary embodiment of the present invention, there is provided a method for transmitting digital broadcasting in a mobile communication terminal having a digital broadcasting receiver and a camera module, including: performing a video call by converting an image signal output from the camera module into image data for transmission and transmitting the image data for transmission; and replacing, upon receipt of a request to replace an image while performing the video call, the image data for transmission with broadcast data for transmission obtained by converting a broadcast signal received from the digital broadcasting receiver and transmitting the broadcast data for transmission.

In accordance with another embodiment of the present invention, there is provided a mobile communication terminal having a digital broadcasting receiver and a camera module, including: an image data converter for converting an image signal output from the camera module into image data for transmission; a broadcast data converter for converting a broadcast signal received from the digital broadcasting receiver into broadcast data for transmission; and a video call executer for performing a video call using the image data for transmission received from the image data converter or the broadcast data for transmission received from the broadcast data converter and replacing, upon receipt of a request to replace an image while performing the video call, the image data for transmission with the broadcast data for transmission, or the broadcast data for transmission with the image data for transmission, to transmit the resulting data.

### BRIEF DESCRIPTION OF THE DRAWINGS

The above features and advantages of the present invention will be more apparent from the following detailed description in conjunction with the accompanying drawings, in which:

FIG. 1 is a signal flow diagram schematically illustrating a method for transmitting digital broadcasting in a mobile communication terminal according to an exemplary embodiment of the present invention;

FIG. 2 is a block diagram illustrating a configuration of a mobile communication terminal according to an exemplary embodiment of the present invention;

FIG. 3 is a flowchart illustrating a method for transmitting digital broadcasting according to an exemplary embodiment of the present invention;

FIGS. 4A-4C illustrate examples of video call screens of a mobile communication terminal according to exemplary embodiments of the present invention; and

FIG. 5 illustrates an example of a video call screen of another party's mobile communication terminal according to an exemplary embodiment of the present invention.

### DETAILED DESCRIPTION OF THE INVENTION

In a mobile communication terminal according to an embodiment of the present invention, a controller described hereinafter preferably includes an image data converter, a broadcast data converter, and a video call executer. Alternatively, the image data converter, the broadcast data converter, and the video call executer may be individually installed and connected to the controller.

Furthermore, elements and regions in the drawings may be schematically illustrated for brevity and clarity. Thus, dimensions of the elements or spacing between elements are not to scale.

In the present embodiment, the terms “image data” and “image data for transmission” used hereinafter refer to motion video data being captured and converted by a camera module. The terms “broadcast data” and “broadcast data for transmission” refer to motion video data being received and converted through a Digital Multimedia Broadcasting (DMB) receiver.

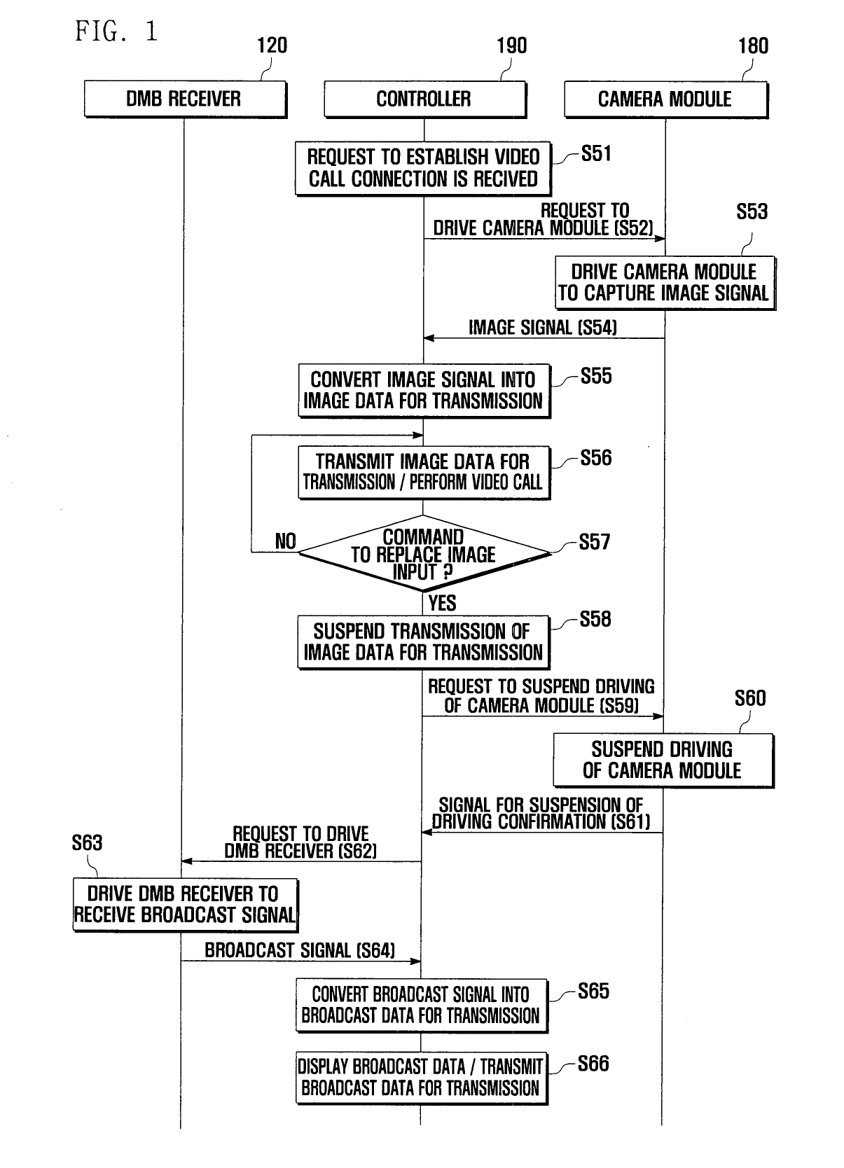

Hereinafter, preferred embodiments of the present invention are described in detail with reference to the accompanying drawings. FIG. 1 is a signal flow diagram schematically illustrating a method for transmitting digital broadcasting in a mobile communication terminal according to an exemplary embodiment of the present invention.

Referring to FIG. 1, a request to establish a video call connection is received by a controller 190 (S51). The controller 190 sends a request to drive a camera sensor and a signal processor to the camera module 180 (S52). Upon receipt of the request, the camera module 180 drives the camera sensor and the signal processor to capture an image signal (S53).

The camera module 180 sends the image signal to the controller 190 (S54). The controller 190 then converts the image signal into image data for transmission (S55) and transmits the image data for transmission to another party's mobile communication terminal to perform a video call (S56).

Thereafter, the controller 190 checks whether a command to replace an image is input by the user during the video call (S57). If a command to replace an image is input, the controller 190 suspends the transmission of image data for transmission (S58) and sends a request to suspend the driving of the camera sensor to the camera module 180 (S59).

The camera module 180 suspends the driving of the camera sensor (S60) and sends a signal to confirm suspension of the driving of the camera sensor to the controller 190 (S61). Upon receipt of the driving suspension confirmation, the controller 190 sends a request to drive a DMB receiver 120 to the DMB receiver 120 (S62).

The driven DMB receiver 120 receives a broadcast signal (S63) and sends the received broadcast signal to the controller 190 (S64).

The controller 190 converts the broadcast signal into broadcast data for transmission (S65), then replaces image data for transmission with the broadcast data for transmission and transmits the broadcast data to another party's mobile communication terminal (S66).

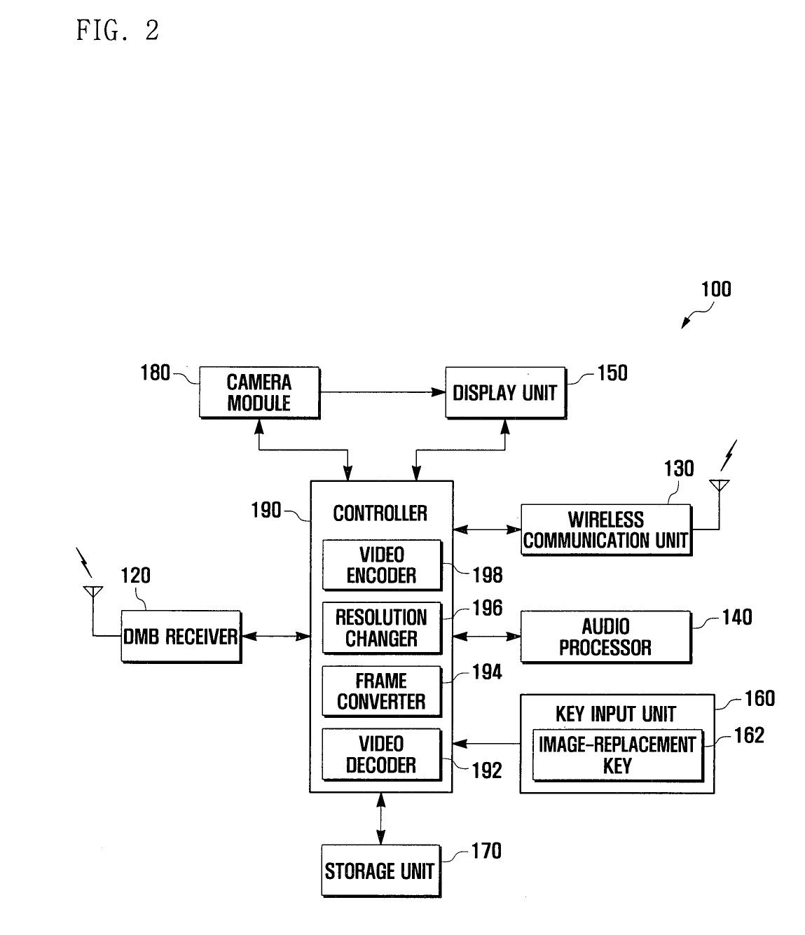

FIG. 2 is a block diagram illustrating a configuration of a mobile communication terminal 100 according to an exemplary embodiment of the present invention.

Referring to FIG. 2, the mobile communication terminal 100 includes a DMB receiver 120, wireless communication unit 130, audio processor 140, key input unit 160, camera module 180, display unit 150, storage unit 170, and controller 190.

The DMB receiver 120 includes a digital broadcasting receiver (not shown) and receives a digital broadcast signal (hereinafter referred to as a “broadcast signal”). For example, the DMB receiver 120 may select a Code Division Multiplexing (CDM) channel corresponding to a broadcasting channel selected by a user for reception. To achieve this, the DMB receiver 120 preferably includes a non-directional antenna.

The wireless communication unit 130 transmits and receives data for wireless communication. To achieve this function, the wireless communication unit 10 includes an RF transmitter that up-converts the frequency of a signal to be transmitted and amplifies the signal and an RF receiver that low-noise amplifies a received signal and down-converts its frequency. The wireless communication unit 130 receives data via a wireless channel to output the data to the controller 190 and receives data from the controller 190 such as image data for transmission or broadcast data for transmission to transmit the data through the wireless channel.

The audio processor 140 includes a coder/decoder (codec). The codec consists of a data codec for processing data such as packet data and an audio codec for processing audio signals such as voice. The audio processor 140 converts digital audio data fed into the controller 190 through the wireless communication unit 130 during a voice call to an analog audio signal through the audio codec and plays back the analog signal through a speaker. The audio processor 140 also converts an analog audio signal received through a microphone to digital audio data through the audio codec and outputs the digital audio data to the controller 190.

The key input unit 160 receives a user's manipulation signal for controlling the mobile communication terminal 100 to output the signal to the controller 190. To achieve this function, the key input unit 160 includes multiple character keys for inputting numeric and character information and control keys for controlling the operation of the mobile communication terminal 100. The key input unit 160 of the present invention further includes an image-replacement key 162 for replacing image data for transmission that is being transmitted to another party with broadcast data for transmission. In the present embodiment, the image-replacement key 162 is realized in software through menu selection. However, the image-replacement key 162 may also be realized in hardware together with the character keys and control keys.

The camera module 180 captures an image formed by a lens of a camera sensor and converts the resulting optical signal to an electrical signal. The camera sensor may be a charge coupled device (CCD) or complementary metal oxide semiconductor (CMOS) sensor.

The camera module 180 also includes a signal processor that converts an analog image signal output from the camera sensor to digital data. The signal processor may be a digital signal processor (DSP) or other signal processor.

The display unit 150 displays image data output from the camera module 180 on a screen. The display unit 150 may be a liquid crystal display (LCD). In this case, the display unit 150 includes an LCD controller, a memory for storing data, and an LCD display element. When the LCD is implemented using a touch screen technology, the screen of the display unit 150 may perform an input function.

The storage unit 170 includes a program memory for storing programs for controlling the operation of the mobile communication terminal 100 and a data memory for storing data generated while executing the programs, image data obtained by converting an image signal input through the camera module 180, and broadcast data obtained by converting a broadcast signal received from the DMB receiver 120.

The controller 190 performs the overall control operation of the mobile communication terminal 100. The controller 190 also generates image data for transmission and broadcast data for transmission using an image signal and a broadcast signal that are output respectively from the camera module 180 and the DMB receiver 120 when making a video call.

In the present embodiment, the controller 190 includes an image data converter, a broadcast data converter, and a video call executer.

The image data converter converts an image signal received from the camera module 180 into image data for transmission.

The broadcast data converter converts a broadcast signal received from the DMB receiver 120 into broadcast data for transmission. In order to process the broadcast signal received from the DMB receiver 120 on a frame-by-frame basis and change the resolution of broadcast data, the broadcast data converter includes a video decoder 192, a frame converter 194, and a resolution changer 196.

The video decoder 192 decodes a broadcast signal received from the DMB receiver 120 into broadcast data.

The frame converter 194 receives the broadcast data from the video decoder 192 and converts the frame rate of the broadcast data into a different frame rate. For example, the frame converter 194 may convert broadcast data having a frame rate of 30 frames-per-second (fps) into broadcast data having a frame rate of 15 fps for easy transmission.

The resolution changer 196 receives the broadcast data from the frame converter 194 and changes the resolution of the broadcast data. For example, the resolution changer 196 may transform broadcast data having Quarter Video Graphics Array (QVGA) resolution (320×240) into data having Quarter Common Intermediate Format (QCIF) resolution (176×144).

The video call executer performs a video call using image data for transmission output by the image converter or broadcast data for transmission output by the broadcast data converter. The video call executer also replaces the image data for transmission with the broadcast data for transmission or the broadcast data for transmission with the image data for transmission when a request to replace an image is input during the video call. To achieve this function, the video call executer of the present embodiment includes a video encoder 198 that encodes the broadcast data processed by the resolution changer 196 or the image data received from the camera module 180 and transmits the encoded broadcast data and image data to the wireless communication unit 130.

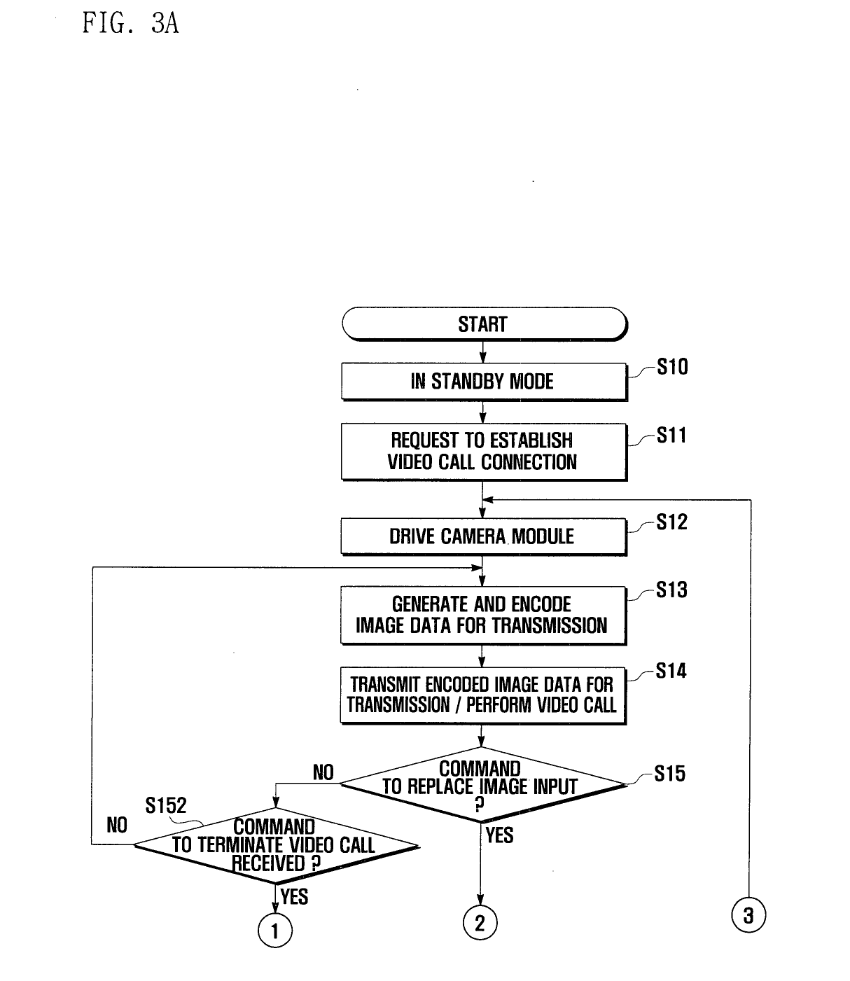

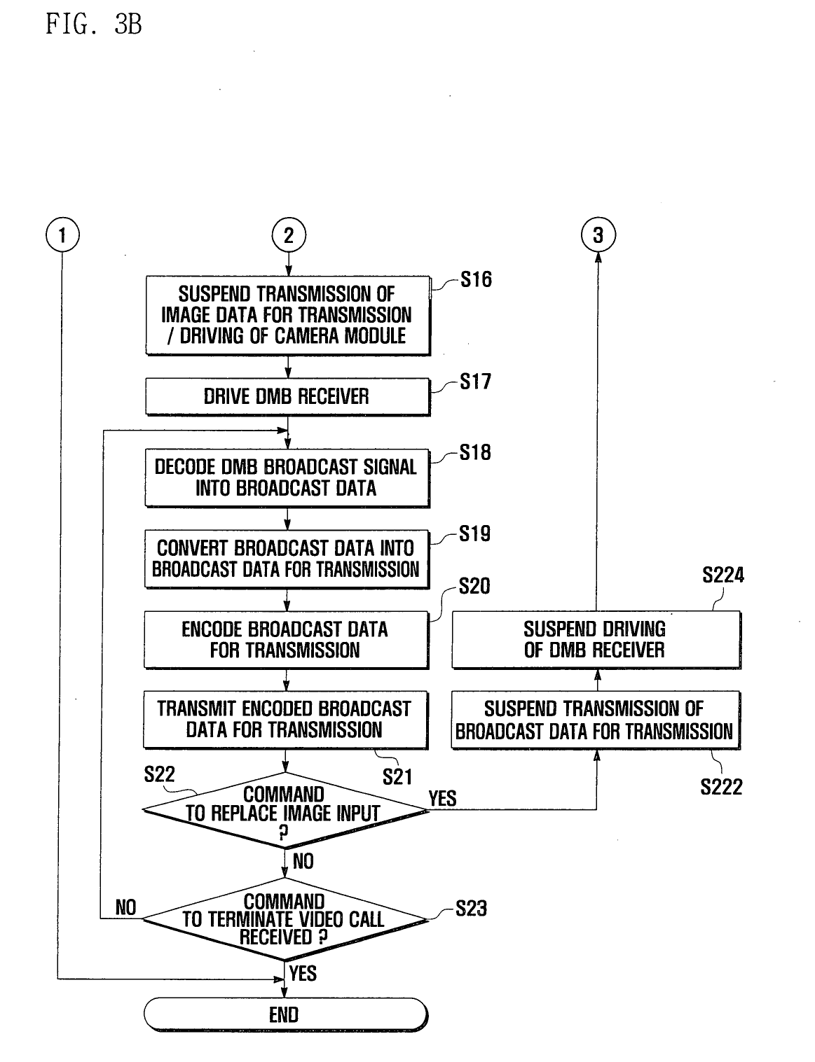

FIG. 3 is a flowchart illustrating a method for transmitting digital broadcasting according to an exemplary embodiment of the present invention.

Referring to FIGS. 1-3, in the state in which the mobile communication terminal 100 is in a standby mode (S10), if a key is input to request a video call (S11), the controller 190 converts the standby mode into a video call mode.

The controller 190 then drives the camera module 180 (S12). More specifically, the camera sensor of the camera module 180 captures an image to generate an image signal. The signal processor 140 receives the image signal to convert the image signal into digital image data such as YUV data. The signal processor also sends the image data to the controller 190, which then sends the image data to the display unit 150 and controls the display unit 150 to display the image data on a screen. In this case, the controller 190 may convert the image data according to the resolution and screen size of the display unit 150, or may first generate image data for transmission, which is described hereinafter, before sending the image data to the display unit 150.

The controller 190 generates the image data for transmission (S13), by converting the image data into image data for transmission and encoding the image data for transmission.

The image data for transmission that is used for a video call according to the present embodiment may be motion video data having QCIF resolution of 176×144 and frame rate of 15 fps or other data having different resolution and frame rate. The frame converter 194 of the controller 190 converts the image data received from the camera module 180 into image data having a frame rate of 15 fps and sends the resulting image data to the resolution changer 196. The resolution changer 196 converts the received image data into image data having QCIF resolution and generates image data for transmission.

If the image data output by the camera module 180 to the controller 190 has the same resolution and frame rate as the image data for transmission according to the present embodiment, the controller 190 uses the image data received from the camera module 180 as the image data for transmission without conversion.

After generating the image data for transmission, the video encoder 198 of the controller 190 encodes the image data for transmission.

Next, the controller 190 controls the wireless communication unit 130 to transmit the encoded image data for transmission to another party's mobile communication terminal and performs a video call with the other party (S14). A video telephony process involving generation of audio data through input of a user's voice, synchronization of the audio data to image data for transmission, and modulation of the resulting data is known in the art, therefore a detailed description is omitted herein.

While the video call is performed in this manner, the display unit 150 displays an image captured by the camera module 180 simultaneously with an image received from the other party's mobile communication terminal.

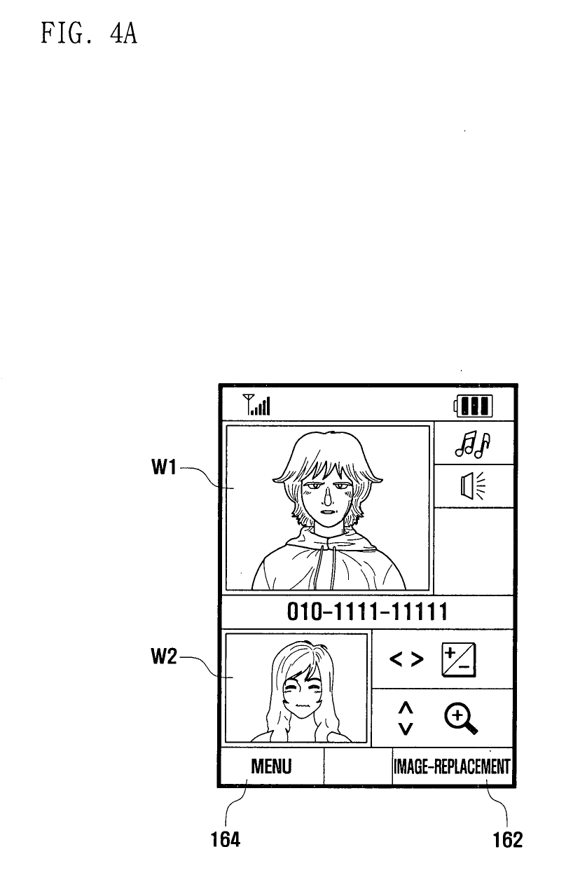

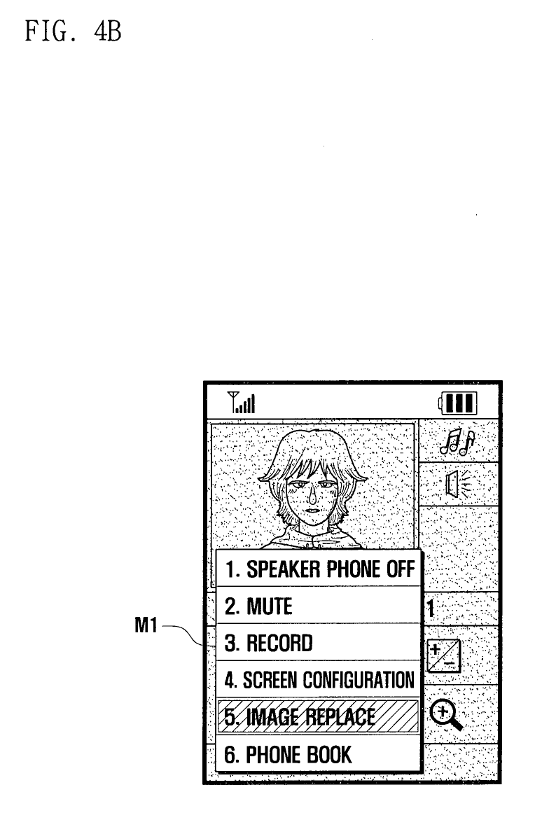

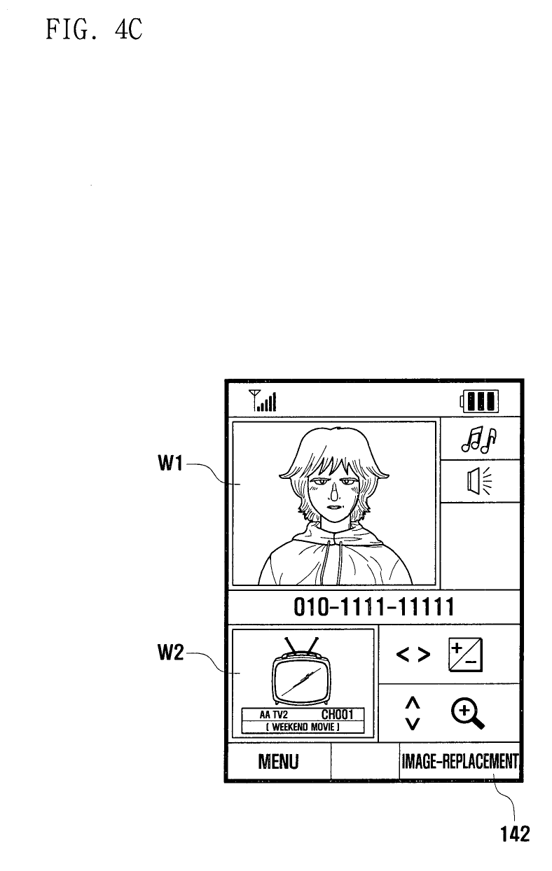

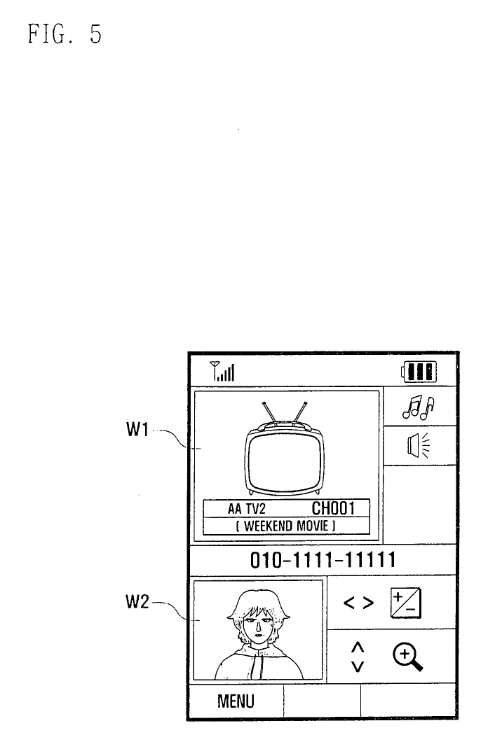

FIGS. 4A-4C illustrate examples of video call screens of the mobile communication terminal 100 according to exemplary embodiments of the present invention. FIG. 5 illustrates an example of a video call screen of another party's mobile communication terminal according to an exemplary embodiment of the present invention.

Referring to FIG. 4A, an image received from the other party's mobile communication terminal is displayed on an upper window W1 in the screen of the display unit 150. An image captured by the camera module 180 is displayed on a lower window W2 of the screen. The images may be displayed at different positions on the screen. The controller 190 then determines whether a command to replace an image is input (S15).

If a command to replace an image is not input, the controller 190 determines whether a command to terminate the video call is received (S152). If a command to terminate the video call is not received, the process returns to step S13 and a video call connection is maintained.

If a user desires to replace an image, the user manipulates the image-replacement key 162 of the key input unit 160, and the controller determines that a command to replace an image is input at step S15. In the present embodiment, the image-replacement key 162 is realized in software. In the example illustrated in FIG. 4A, the image-replacement key 162 is displayed on a lower rightmost portion of the screen. For another example, as illustrated in FIG. 4B, a menu window M1 containing menu items may be displayed upon the user's selection of a menu key 164, and the user selects one of a plurality of menu items in the menu window M1 (for example, item 5 Image Replacement) to input a command to replace an image.

Upon receiving the command to replace an image, the controller 190 suspends the transmission of image data for transmission and driving of the camera module 180 (S16), and drives the DMB receiver 120 (S17).

The DMB receiver 120 is driven by the controller 190 to receive a broadcast signal and continues to transmit the broadcast signal to the controller 190.

The video decoder 192 of the controller 190 decodes the broadcast signal received from the DMB receiver 120 to broadcast data (S18).

Next, the controller 190 converts the decoded broadcast data into broadcast data for transmission (S19). The broadcast data has general image formats for DMB, i.e. QVGA resolution (320×240) and frame rate of 30 fps. Because the broadcast data is transmitted and viewed using a video call in the present embodiment, the controller 190 creates the broadcast data for transmission having the same formats (i.e. QCIF resolution and frame rate of 15 fbs) as image data for transmission.

More specifically, the frame converter 194 converts broadcast data having a frame rate of 30 fps into broadcast data having a frame rate of 15 fps. After converting the frame rate in this manner, the resolution changer 196 of the controller 190 transforms the broadcast data having QVGA resolution into broadcast data having QCIF resolution. As a result of frame conversion and resolution change, the controller 190 creates broadcast data for transmission having QCIF resolution and frame rate of 15 fps.

After the broadcast data for transmission is created, the video encoder 198 encodes the broadcast data for transmission (S20). The controller 190 then controls the wireless communication unit 130 to transmit the encoded broadcast data for transmission to the other party's mobile communication terminal (S21). As illustrated in FIG. 5, a broadcast image received by the DMB receiver 120 is then displayed on an upper window OW1 of a screen of the other party's mobile communication terminal, instead of an image captured by the camera module 180. Thus, the other party is able to view a desired digital broadcast through a video call without having a DMB receiver.

Meanwhile, as illustrated in FIG. 4C, the other party's image, transmitted by the other party and received by the mobile communication terminal 100, is displayed on the upper window W1 in the screen of the display unit 150 of the mobile communication terminal 100 while the broadcast data (or broadcast data for transmission) is displayed on the lower window W2.

After the broadcast data for transmission is transmitted by replacing the image data for transmission, the controller 190 determines whether a command to replace an image is input (S22). If a command to replace an image is not input, the controller 190 determines whether a command to terminate the video call is input (S23). If a command to terminate the video call is not input, the process returns to step S18 and the controller 190 maintains the video call connection by transmitting broadcast data for transmission to the other party's mobile communication terminal.

If a command to replace an image is input at step S22, the controller 190 suspends transmission of the broadcast data for transmission (S222) and suspends driving of the DMB receiver 120 (S224) and the process returns to step S12. That is, the controller 190 drives the camera module 180 to generate image data for transmission and transmits the image data for transmission to the other party's mobile communication terminal to perform a video call.

The controller 190 continuously receives a broadcast signal from the DMB receiver 120, if broadcast data is requested, converts the broadcast signal into broadcast data for transmission, and transmits the broadcast data for transmission to the other party in real time. Thus, the broadcast data for transmission is preferably buffered in an internal buffer (not shown) of the storage unit 170 or controller 190 before transmission. The same applies to transmission of image data for transmission.

Further, the controller 190 creates broadcast data for transmission using only a video portion of broadcast data. That is, the broadcast data for transmission does not contain audio data and user voice data is used as the audio portion. This is intended to maintain a video call connection between two parties even when broadcast data for transmission is transmitted to the party not having a DMB receiver, and displayed on their mobile communication terminal.

However, audio data may be generated using a broadcast signal and then transmitted together with video data. In this case, audio data may be combined with voice call data for transmission. This method, however, has a drawback in that it is difficult for the other party to distinguish voice call data from audio data. Thus, a method for overcoming the drawback is to generate and transmit only voice call data when transmitting image data for transmission and only audio data when transmitting broadcast data for transmission.

The present invention enables transmission of broadcast data for transmission, obtained by converting a broadcast signal received through a DMB receiver, by replacing image data for transmission, thus allowing viewing of digital broadcasts on a mobile communication terminal not equipped with a DMB receiver through a video call.

While the present invention has been particularly shown and described with reference to embodiments thereof, it will be understood by those of ordinary skill in the art that various changes in form and details may be made therein without departing from the spirit and scope of the present invention as defined by the following claims. For example, whereas in the above description a controller according to the present invention includes a video decoder, a frame converter, a resolution changer, and a video encoder, the components may be installed separately from the controller.

Further, although in the above description, broadcast data for transmission is replace with image data for transmission or vice versa when a command to replace an image is input, various other methods may be applied. For example, desired image data may be selected for transmission, among various kinds of image data such as separately stored motion video data, still image data, in addition to broadcast image data for transmission.

What is claimed is:

1. A method for transmitting digital broadcasting in a mobile communication terminal having a digital broadcasting receiver and a camera module, comprising:
performing a video call by converting an image signal output from the camera module into image data for transmission and transmitting the image data for transmission; and
replacing, upon receipt of a request to replace an image while performing the video call, the image data for transmission with broadcast data for transmission obtained by converting a broadcast signal received from the digital broadcasting receiver and transmitting the broadcast data for transmission.

2. The method of claim 1, wherein performing a video call comprises:
driving the camera module in response to a request to establish a video call connection;
receiving an image signal from the driven camera module;
converting the received image signal into image data for transmission; and
transmitting the image data for transmission.

3. The method of claim 2, wherein transmitting the image data for transmission comprises displaying the image data for transmission on a screen.

4. The method of claim 1, wherein replacing the image data for transmission with broadcast data for transmission and transmitting the broadcast data for transmission comprises:
suspending, upon receipt of the request to replace an image, transmission of the image data for transmission;
driving the digital broadcasting receiver after suspending the transmission of the image data for transmission;
receiving a broadcast signal from the driven digital broadcasting receiver;
converting broadcast signal into the broadcast data for transmission; and
transmitting the broadcast data for transmission.

5. The method of claim 4, wherein suspending transmission of the image data comprises:
suspending, upon receipt of the request to replace an image, conversion and transmission of the image data for transmission; and
suspending driving of the camera module.

6. The method of claim 4, wherein converting the broadcast signal into the broadcast data for transmission comprises:
decoding the received broadcast signal into broadcast data;
converting a frame rate of the decoded broadcast data into a different frame rate; and
changing the resolution of the resulting broadcast data to generate the broadcast data for transmission.

7. The method of claim 4, wherein converting broadcast signal into the broadcast data for transmission further comprises, before transmitting the broadcast data for transmission, encoding the broadcast data for transmission.

8. The method of claim 6, wherein in the step of converting a frame rate of the decoded broadcast data into a different frame rate, the broadcast data for transmission is converted to have the same frame rate as the image data for transmission.

9. The method of claim 6, wherein in the step of changing the resolution of the broadcast data, the broadcast data for transmission is converted to have the same resolution as the image data for transmission.

10. The method of claim 1, wherein replacing the image data for transmission with broadcast data for transmission and transmitting the broadcast data for transmission further comprises suspending, upon receipt of the request to replace an image while transmitting the broadcast data for transmission, transmission of the broadcast data for transmission and driving the camera module to transmit the image data for transmission.

11. The method of claim 1, wherein in the step of replacing the image data for transmission with broadcast data for transmission and transmitting the broadcast data for transmission, the video call connection is maintained while transmitting the broadcast data for transmission.

12. The method of claim 1, wherein in the step of replacing the image data for transmission with broadcast data for transmission and transmitting the broadcast data for transmission, audio data generated using the broadcast signal is transmitted together while transmitting the broadcast data for transmission.

13. A mobile communication terminal having a digital broadcasting receiver and a camera module, comprising:
an image data converter for converting an image signal output from the camera module into image data for transmission;
a broadcast data converter for converting a broadcast signal received from the digital broadcasting receiver into broadcast data for transmission; and
a video call executer for performing a video call using the image data for transmission received from the image data converter or the broadcast data for transmission received from the broadcast data converter and replacing, upon receipt of a request to replace an image while performing the video call, the image data for transmission with the broadcast data for transmission or the broadcast data for transmission with the image data for transmission to transmit the resulting data.

14. The terminal of claim 13, wherein the broadcast data converter comprises:
a video decoder for decoding the broadcast signal received from the digital broadcasting receiver into broadcast data;
a frame converter for converting a frame rate of the broadcast data received from the video decoder into a different frame rate; and
a resolution changer for changing the resolution of the broadcast data obtained by the frame converter to generate the broadcast data for transmission.

15. The terminal of claim 13, further comprising a video encoder for receiving the image data for transmission from the image data converter or the broadcast data for transmission from the broadcast data converter to encode the received data.
